(19) United States
(12) Patent Application Publication
(10) Pub. No.: US 2021/0146469 A1
(43) Pub. Date: May 20, 2021

(54) REVERSE POLARITY PLASMA ARC ROBOT ADDITIVE MANUFACTURING SYSTEM AND IMPLEMENTATION METHOD THEREFOR

(71) Applicant: SOUTH CHINA UNIVERSITY OF TECHNOLOGY, Guangzhou City (CN)

(72) Inventors: Zhenmin WANG, Guangzhou City (CN); Fubiao ZHANG, Guangzhou City (CN); Junhao WEI, Guangzhou City (CN); Pengfei WANG, Guangzhou City (CN)

(73) Assignee: SOUTH CHINA UNIVERSITY OF TECHNOLOGY, Guangzhou City (CN)

(21) Appl. No.: 16/625,746

(22) PCT Filed: Nov. 23, 2017
(86) PCT No.: PCT/CN2017/112636

§ 371 Date: Dec. 22, 2019

(30) Foreign Application Priority Data
Jun. 22, 2017 (CN) 201710479299.7

(51) Int. Cl. B23K 10/00; B23K 10/02; H05H 1/36; H05H 1/34; B33Y 30/00; B33Y 10/00; B33Y 50/02

(52) U.S. Cl. CPC B23K 10/006; B23K 10/027; H05H 1/36; B33Y 50/02; B33Y 30/00; B33Y 10/00; H05H 1/341

(57) ABSTRACT

Disclosed are a reverse polarity plasma arc robot additive manufacturing system and an implementation method therefor, the system comprising an industrial robot, an additive manufacturing power source, a wire feeding machine, a machine visual system, an industrial computer, a plasma welding gun, a refrigerating device, a gas device and an auxiliary tool fixture. The industrial robot, the additive manufacturing power source, the wire feeding machine, the refrigerating device, the gas device and the auxiliary tool fixture are all connected to the industrial computer via a CAN bus; the machine visual system is connected to the industrial computer by means of a TCP/IP protocol; the plasma welding gun is connected to the refrigerating device, the additive manufacturing power source, the wire feeding machine, the gas device and the auxiliary tool fixture; and the refrigerating device is further connected to the additive manufacturing power source. The additive manufacturing power source comprises a main-arc power source and a pilot-arc power source, and the main-arc power source and the pilot-arc power source are both connected to the plasma welding gun; and the main-arc power source comprises a main-arc power source main circuit and a main-arc power source control circuit, and the pilot-arc power source comprises a pilot-arc power source main circuit, a pilot-arc power source control circuit and a high-frequency and high-voltage arc ignition circuit. The additive manufacturing power source not only realizes the inverse change of the high-frequency and high-efficiency, but also realizes the integration and digital integration of the pilot-arc power source and the main-arc power source. The main-arc power source and the pilot-arc power source are digitally coordinated by means of a CAN network, and the volume of same is compact, the compatibility is better, the field environment is more adaptable, and the expansion capability is stronger.

### TECHNICAL FIELD

The present invention relates to the technical field of welding and additive manufacturing, and in particular to a reverse polarity plasma arc robot additive manufacturing system and an implementation method therefor.

### BACKGROUND ART

Additive manufacturing is a “bottom-up” manufacturing method that uses a layer-by-layer accumulation of materials to make solid parts. Metal-based additive manufacturing technology mainly uses a laser and electron beam as a heat source, and produces complex parts continuously and layer-by-layer by continuously melting or sintering metal powders. In recent years, due to limitations such as the slow forming speed of the laser heat source and the small volume of components that can be processed by electron beams, low-cost and high-efficiency arc-based additive manufacturing technologies have received great attention. Reverse polarity plasma arc additive manufacturing uses a combined or transfer type plasma arc as the heat source and uses an alloy powder or wire as a filler metal to effectively melt and bond a surfacing metal and a base metal to form a high-density, high-degree-of-bonding, low-dilution-rate surfacing structure to achieve additive manufacturing. Plasma arc additive manufacturing can not only repair damaged components, but also manufacture complex metal parts with small, uniform and dense structures.

In recent years, the wire-based reverse polarity plasma arc additive manufacturing has become a research focus. The reverse polarity plasma arc additive manufacturing is a highly integrated, intelligent, and automated system. In a plasma arc additive manufacturing system, the performance of a plasma power source, which provides energy during additive manufacturing, is critical. There is still a large gap between the industrialization levels of plasma power source equipment in China and developed countries. Universal welding power sources are commonly used to manufacture workpieces, and there are few dedicated reverse polarity, digitized, high-performance specialized plasma additive manufacturing power sources. Moreover, when using wire fused deposition additive manufacturing, the stability, uniformity, and collaboration capability of the wire feeding system are also very important, which directly affects the stability of the additive process, the morphology of the additive material, and the processing flow.

### SUMMARY OF THE INVENTION

The technical problems to be solved by the present invention are to provide a reverse polarity plasma arc robotic additive manufacturing system and a implementation method therefor. The system has a simple topological structure and full digitized control, and can adopt any desired current waveform for additive manufacturing according to the characteristics of materials and workpieces, has a good process adaptability, and can improve the process quality of additive manufacturing.

In order to solve the above-mentioned technical problem, the technical solution provided by the present invention is as follows: a reverse polarity plasma arc robot additive manufacturing system, comprising an industrial robot, an additive manufacturing power source, a wire feeding machine, a machine visual system, an industrial computer, a plasma welding gun, a refrigerating device, a gas device and an auxiliary tooling fixture, wherein the industrial robot, the additive manufacturing power source, the wire feeding machine, the refrigerating device, the gas device and the auxiliary tooling fixture are all connected to the industrial computer via a CAN bus; the machine visual system is connected to the industrial computer over a TCP/IP protocol; the plasma welding gun is connected to the refrigerating device, the additive manufacturing power source, the wire feeding machine, the gas device and the auxiliary tooling fixture; and the refrigerating device is further connected to the additive manufacturing power source, wherein

the machine visual system is used to detect information of a workpiece to be additively manufactured and location information thereof, and feed the information into the industrial computer; the machine visual system is used to identify a path, monitor a state and track the workpiece during additive manufacturing;

the industrial computer is used to select an additive manufacturing mode and a basic process parameter supporting same, and plan an additive path; the industrial computer performs data processing and remote monitoring on the industrial robot, the additive manufacturing power source, the wire feeding machine, the gas device and the auxiliary tooling fixture during the additive manufacturing;

the industrial robot serves as an execution mechanism for controlling the plasma welding gun and the auxiliary tooling fixture to complete corresponding action operations;

the additive manufacturing power source is used to provide energy required during the additive manufacturing;

the wire feeding machine is used to convey a wire and adjust a feeding speed;

the plasma welding gun is used to complete energy conversion so as to provide energy and power for wire fused deposition and transition of molten metal;

the refrigerating device is used to provide cooling for the additive manufacturing power source and the plasma welding gun;

the gas device is used to provide an ionized gas and a shielding gas to the plasma welding gun; and

the auxiliary tooling fixture is used to complete clamping and displacement operations of the workpiece.

Further, the additive manufacturing power source comprises a main-arc power source and a pilot-arc power source, and the main-arc power source and the pilot-arc power source are both connected to the plasma welding gun; and the main-arc power source comprises a main-arc power source main circuit and a main-arc power source control circuit, and the pilot-arc power source comprises a pilot-arc power source main circuit, a pilot-arc power source control circuit and a high-frequency and high-voltage arc ignition circuit, wherein

the main-arc power source main circuit is used to realize the conversion and transmission of main-arc energy;

the main-arc power source control circuit is used to control the normal work of the main-arc power source for each task;

the pilot-arc power source main circuit is used to realize the conversion and transmission of pilot-arc energy;

the pilot-arc power source control circuit is used to control the normal work of the pilot-arc power source for each task; and

the high-frequency and high-voltage arc ignition circuit is used to break down an air gap between a tungsten electrode and a nozzle of the plasma welding gun to establish and sustain an arc.

Further, the main-arc power source main circuit adopts a dual inverter topology, comprising an input rectification and filtering module, an IGBT high-frequency inverter circuit, an intermediate-frequency transformer, a fast rectification and filtering module, an IGBT low-frequency modulation circuit, and a high-voltage arc stabilization circuit, wherein the input rectification and filtering module is used to convert 380V three-phase alternating current into smooth direct current; the IGBT high-frequency inverter circuit is used to invert the rectified direct current into high-frequency alternating current; the intermediate-frequency transformer is used for energy conversion, so as to provide high-current and low-voltage alternating current required during the additive manufacturing; the fast rectification and filtering module is used to convert the alternating current, which has passed through the intermediate-frequency transformer, into large-current and low-voltage direct current; the IGBT low-frequency modulation circuit is used to perform commutation adjustment, frequency modulation, and inductive filtering on the direct current, which has passed through the fast rectification and filtering module, to output required current and voltage waveforms; and the high-voltage arc stabilization circuit is used to ensure that a relatively high voltage is applied at the time of polarity inverting of the output current of the IGBT low-frequency modulation circuit to ensure reliable re-ignition of the arc when the current crosses zero.

Further, the main-arc power source control circuit comprises a DSC controller, a high-frequency inverter drive circuit, an over-current detection circuit, a current feedback circuit, a low-frequency modulation drive circuit, an arc stabilization circuit drive circuit, a human-machine interaction system, an overheat detection circuit, an over-voltage detection circuit, an under-voltage detection circuit and a CAN communication interface circuit, wherein

the DSC controller generates three sets of all-digitized PWM control signals, and controls the low-frequency modulation drive circuit, the high-frequency inverter drive circuit, and the arc stabilization circuit drive circuit respectively;

the high-frequency inverter drive circuit is used to convert the PWM control signal generated by the DSC controller into a drive signal required by a power switching transistor IGBT in the IGBT high-frequency inverter circuit;

the over-current detection circuit is used to prevent the current passing through the power switching transistor IGBT from being excessive;

the current feedback circuit is used to implement closed-loop adjustment of the output current of the power source;

the low-frequency modulation drive circuit is used to convert the PWM control signal generated by the DSC controller into a drive signal required by a power switching transistor IGBT in the IGBT low-frequency modulation circuit;

the arc stabilization circuit drive circuit is used to convert the PWM control signal generated by the DSC controller into a drive signal required by a power switching transistor IGBT in the high-voltage arc stabilization circuit;

the human-machine interaction system is used to implement a dialog between a human and the power source;

the overheat detection circuit is used to prevent the temperatures of the power switching transistor IGBTs from becoming too high;

the over-voltage detection circuit is used to detect whether the 380V three-phase alternating-current voltage input by the power source is too high;

the under-voltage detection circuit is used to detect whether the 380V three-phase alternating-current voltage input by the power source is too low; and

the CAN communication interface circuit is used to communicate with other systems to achieve digitized collaboration.

Further, the DSC controller comprises a DSC microcontroller, a power source power supply module, an external clock circuit, a reset circuit, and a JTAG debug and download circuit.

Further, the pilot-arc power source main circuit comprises an input rectification and filtering module, a MOSFET inverter circuit, an intermediate-frequency transformer, and a fast rectification and filtering module, wherein the input rectification and filtering module is used to convert 380V three-phase alternating current into smooth direct current; the MOSFET inverter circuit is used to invert the rectified direct current into high-frequency alternating current; the intermediate-frequency transformer is used for energy conversion, so as to obtain high-current and low-voltage alternating current; and the fast rectification and filtering module is used to convert the alternating current, which has passed through the intermediate-frequency transformer, into large-current and low-voltage direct current.

Further, the wire feeding machine comprises a wire feeding control system, a high-frequency AC/DC inverter, a wire feeding drive circuit, a wire feeding motor, pinch rollers, and a fixed bracket, wherein the wire feeding control system comprises a DSC controller, an optocoupler isolation module, a voltage sampling module, a transformer filtering module, a power supply module, a fault detection module and a CAN driver.

Further, the wire feeding drive circuit comprises a high-frequency half-bridge chopper circuit, two diodes, a relay switch, an optocoupler, and a motor load.

Another object of the present invention is to provide a method for implementing a reverse polarity plasma arc robot additive manufacturing system, comprising the following steps:

S1. selecting, by an industrial computer according to the characteristics of a workpiece and a wire therefor, a corresponding additive manufacturing mode and a basic process parameter supporting same; and detecting, by a machine visual system, information of the workpiece to be additively manufactured and the position thereof, and feeding the information into the industrial computer and plan an additive path to coordinate the movements of an industrial robot and an auxiliary tooling fixture to corresponding workstations;

S2. activating a refrigerating device and a gas device to prepare for the work of a plasma welding gun and an additive manufacturing power source;

S3. switching on a three-phase power source to supply power to the additive manufacturing power source and a wire feeding machine for conducting an additive manufacturing work; and

S4. feeding the wire stably by the wire feeding machine according to process requirements pre-set by the industrial computer, and melting the wire by a plasma arc jet generated by the plasma welding gun, and stacking and shaping the wire following the corresponding path.

Further, in step S3, after the three-phase power source supplies power to the additive manufacturing power source, a pilot-arc power source of the additive manufacturing power source works first, a high-frequency and high-voltage arc ignition circuit is used to generate a high-frequency and high-voltage signal to break down an air gap between a tungsten electrode and a nozzle of the plasma welding gun to establish and sustain an arc with a very small current; after the ignition of the arc is successful, a DSC controller of the pilot-arc power source sends a pilot-arc success signal to a DSC controller of a main-arc power source, and the main-arc power source is activated to generate a transfer arc between the workpiece and the tungsten electrode; after the transfer arc is successful, the additive manufacturing system can turn off a pilot arc according to the requirements of materials and processes, so as to perform the additive manufacturing process in the case of the transfer arc; and the pilot arc can also continue to work, so as to form a mixed arc of the pilot arc and the transfer arc for additive manufacturing, wherein, in order to finely control the amount of heat input and the amount of molten metal, an output waveform of the main-arc power source includes reverse polarity, variable polarity, and pulse; and the wire feeding speed is constant or is a variable speed or changes in a pulsating manner.

According to the technical solutions stated above, the present invention has at least the following benefits:

1. the additive manufacturing power source of the present invention not only realizes a high-frequency and high-efficiency inverse change, but also realizes the integration and digitized integration of the pilot-arc power source and the main-arc power source; and the main-arc power source and the pilot-arc power source are digitally coordinated over a CAN network, and the volume of same is compact, the compatibility is better, the adaptability to the on-site environment is better, and the expansion capability is stronger;

2. the reverse polarity plasma arc robotic additive manufacturing system of the present invention realizes modularization and digitized integration of all key components through DSC-based high-speed and high-precision all-digitized control technology and CAN bus network collaboration technology, and has a better flexibility, a higher precision, more precise control and more guaranteed quality;

3. the additive manufacturing power source in the present invention can realize various working modes such as transfer arc, mixed transfer arc and non-transfer arc, etc., can realize precise output of various polarities and arbitrary shape waveforms, and can realize high-quality control over heat and mass transfer during additive manufacturing by means of a digitized wire feeding machine, thereby improving the additive quality; and

4. the present invention adopts a DSC-based precisely-controlled high-frequency half-bridge chopper drive method, which can realize various wire feeding modes such as forward rotation, reverse rotation and pulsation, so that the wire feeding process is more stable and the anti-disturbance ability is stronger.

### BRIEF DESCRIPTION OF THE DRAWINGS

FIG. 1 is a schematic structural diagram of a reverse polarity plasma arc robot additive manufacturing system of the present invention;

FIG. 2 is a schematic structural diagram of an additive manufacturing power source in the reverse polarity plasma arc robot additive manufacturing system of the present invention;

FIG. 3 is a schematic circuit diagram of a main-arc power source main circuit in the reverse polarity plasma arc robot additive manufacturing system of the present invention;

FIG. 4 is a schematic structural diagram of the main-arc power source control circuit in the reverse polarity plasma arc robot additive manufacturing system of the present invention;

FIG. 5 is a schematic diagram of circuit structure of a DSC controller in the reverse polarity plasma arc robot additive manufacturing system of the present invention;

FIG. 6 is a schematic diagram of circuit structure of a high-frequency inverter drive circuit in the reverse polarity plasma arc robot additive manufacturing system of the present invention;

FIG. 7 is a schematic diagram of circuit structure of a low-frequency modulation drive circuit in the reverse polarity plasma arc robot additive manufacturing system of the present invention;

FIG. 8 is an illustrative diagram of a pilot-arc power source main circuit in the reverse polarity plasma arc robot additive manufacturing system of the present invention;

FIG. 9 is an illustrative circuit diagram of a wire feeding machine control system in the reverse polarity plasma arc robot additive manufacturing system of the present invention; and

FIG. 10 is an illustrative circuit diagram of a wire feeding drive circuit in a wire feeding machine in the reverse polarity plasma arc robot additive manufacturing system of the present invention.

### DETAILED DESCRIPTION OF EMBODIMENTS

It should be noted that, in the case of no conflict, the embodiments and the features thereof in the present application can be combined with each other. The present application is further described below in detail with reference to the drawings and specific embodiments.

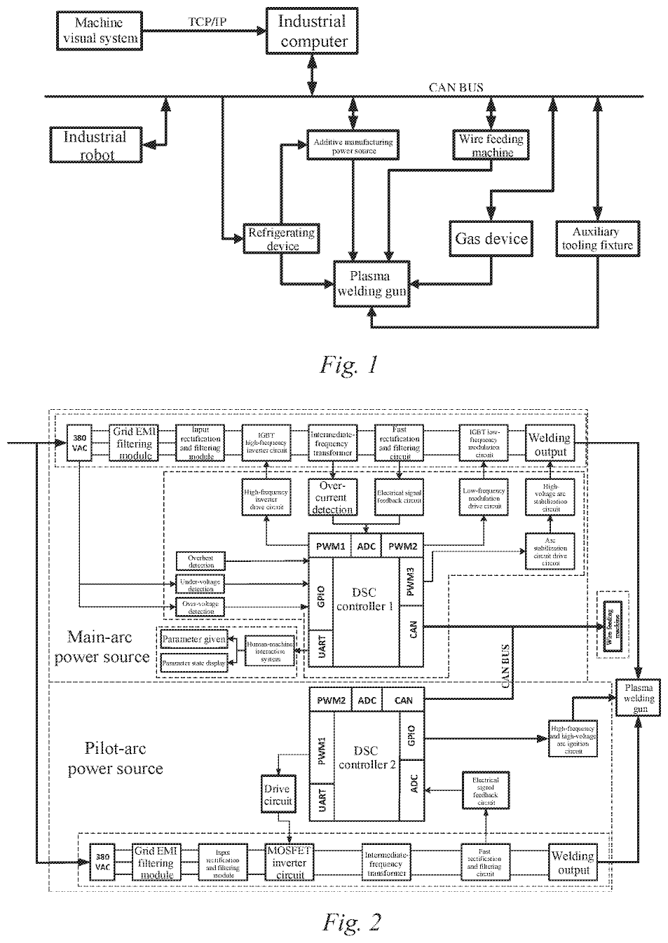

As shown in FIG. 1, the present invention provides a reverse polarity plasma arc robot additive manufacturing system, comprising an industrial robot, an additive manufacturing power source, a wire feeding machine, a machine visual system, an industrial computer, a plasma welding gun, a refrigerating device, a gas device, an auxiliary tooling fixture, etc. The industrial robot, the additive manufacturing power source, the wire feeding machine, the refrigerating device, the gas device and the auxiliary tooling fixture are all connected to the industrial computer via a CAN bus.

The machine visual system is connected to the industrial computer over TCP/IP. The refrigerating device is further connected to the additive manufacturing power source and the plasma welding gun respectively. The wire feeding machine is further connected to the plasma welding gun. The gas device is connected to the plasma welding gun. The auxiliary tooling fixture is connected to the plasma welding gun.

The industrial robot serves as an execution mechanism, which mainly completes the position and pose adjustment of the welding gun and clamps the welding gun to perform the corresponding movement.

Among the main circuit and the DSC control circuit of the additive manufacturing power source, the main circuit part of the welding power source that realizes the conversion and transmission of energy during welding, is the core part of the entire welding system; and the DSC control circuit thereof that mainly implements the generation of power switching transistor PWM drive signals, the PID adjustment on sampling signals, the communication processing of the human-machine interaction system and the wire feeding system, the related protection for the main circuit and other functions, is responsible for the process control of the entire additive manufacturing process and is therefore the “brain” of the entire welding power source.

The wire feeding machine is responsible for adjusting the wire feeding speed. The wire feeding speed must be well matched with parameters such as the magnitude of current during additive manufacturing and the speed during fused deposition additive manufacturing so as to reduce the occurrence of welding defects, so the wire feeding speed must have a wide adjustment range to ensure the anti-interference performance and wire feeding stability of the wire feeding system.

The machine visual system is mainly used for realizing functions such as path identification, state monitoring, and tracking during the additive manufacturing process. The industrial computer mainly performs functions such as coordinated control over various parts of the system, hierarchical planning, and expert system.

The plasma welding gun mainly completes energy conversion so as to provide energy and power for wire fused deposition and transition of molten metal. The refrigerating device mainly provides cooling for the additive manufacturing power source and the plasma welding gun. The gas device mainly provides an ionized gas and a shielding gas. The auxiliary tooling fixture mainly performs functions such as clamping and displacement of the workpiece.

As shown in FIG. 2, the additive manufacturing power source includes a main-arc power source and a pilot-arc power source. The main-arc power source comprises a main circuit and a control circuit. The pilot-arc power source comprises a main circuit, a control circuit and a high-frequency and high-voltage arc ignition circuit. The main-arc power source is connected to the pilot-arc power source via the CAN bus. The main-arc power source and the pilot-arc power source are both directly connected to the plasma welding gun. The control circuits of the main-arc power source and the pilot-arc power source use DSC controllers with the same hardware structure, which differ only in the running software system, thereby reducing development costs and cycles, and improving compatibility and scalability. In the normal work, the DSC controller 2 of the pilot-arc power source first controls the high-frequency and high-voltage arc ignition circuit to work. A non-transfer arc is generated between the tungsten electrode and the nozzle of the plasma welding gun, which is called a pilot arc. After the ignition of the arc is successful, the high-frequency and high-voltage arc ignition circuit is turned off. The DSC controller 2 then sends a pilot-arc success signal to the DSC controller 1 of the main-arc power source via the CAN bus, and the main-arc power source then works to cause the plasma welding gun to generate a transfer arc between the tungsten electrode and the workpiece, which becomes a main arc. The plasma arc additive manufacturing is then performed according to predetermined parameters. The pilot arc and the main arc may coexist, or they may exist alone.

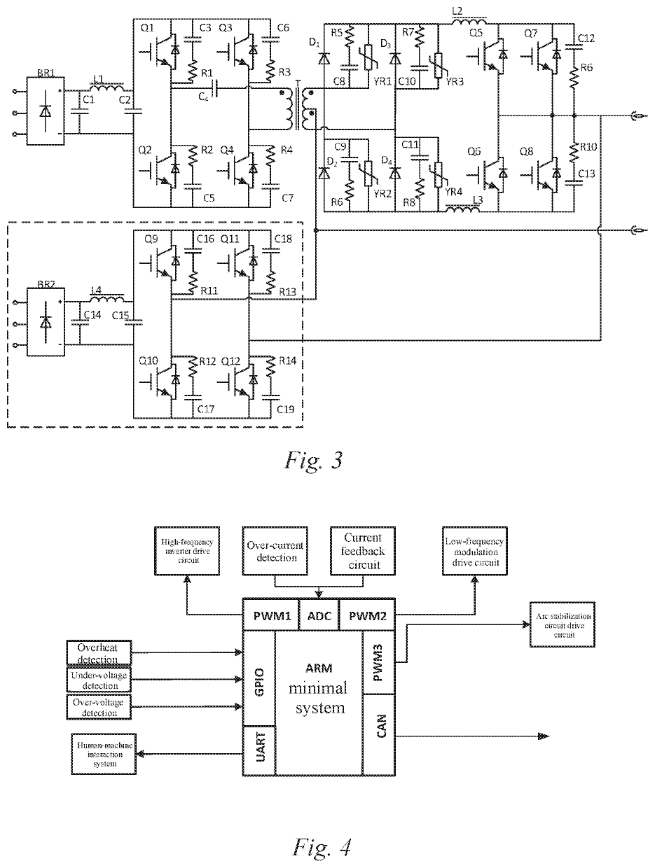

As shown in FIG. 3, the main-arc power source main circuit adopts a dual inverter topology, which mainly includes an input rectification and filtering module BR1, C1-C2, L1, an IGBT high-frequency inverter circuit Q1-Q4, C3-C7, R1-R4, an intermediate-frequency transformer T, a fast rectification filter module D1-D4, R5-R8, YR1-YR4, C8-C11, L2-L3, an IGBT low-frequency modulation circuit Q5-Q8, and a high-voltage arc stabilization circuit BR2, L4, C14-C15, Q9-Q12, C16-C19, R11-R14. The working principle thereof is that the 380V three-phase alternating current is converted by the input rectification and filtering module into a smooth direct current, which then passes through the IGBT high-frequency inverter circuit to achieve constant current characteristic control and dynamic characteristic adjustment. The high-frequency inverted alternating current, after energy conversion performed by the intermediate-frequency transformer, is converted into high-current and low-voltage alternating current required during the additive manufacturing, which then passes through the fast rectification and filtering module and is converted into large-current and low-voltage direct current, and finally passes through the IGBT low-frequency modulation circuit for commutation adjustment, frequency modulation and inductive filtering at an output end, such that the required current and voltage waveforms are output. The IGBT high-frequency inverter circuit adopts a full-bridge topology consisting of four IGBTs, and the direct current component of a primary side of the transformer is filtered by connecting a direct current blocking capacitor C4 in series, thereby preventing a magnetic core from being saturated due to imbalance in volt-seconds. Comprehensively considering factors such as cost and safety, the IGBT low-frequency modulation circuit uses two half-bridges connected in parallel to form a double-half-bridge parallel topology. The dashed box is a high-voltage arc stabilization circuit, which mainly functions to ensure that a relatively high voltage is applied by the main-arc power source at the time of polarity switching of the output current to ensure reliable re-ignition of the arc when the current crosses zero.

As shown in FIG. 4, the main-arc power source control circuit mainly comprises a DSC controller, a high-frequency inverter drive circuit, an over-current detection circuit, a current feedback circuit, a low-frequency modulation drive circuit, an arc stabilization circuit drive circuit, a human-machine interaction system, an overheat detection circuit, an over-voltage detection circuit, an under-voltage detection circuit and a CAN communication interface circuit. The DSC controller directly generates three sets of all-digitized PWM control signals, and controls the low-frequency modulation drive circuit, the high-frequency inverter drive circuit, and the arc stabilization circuit drive circuit respectively.

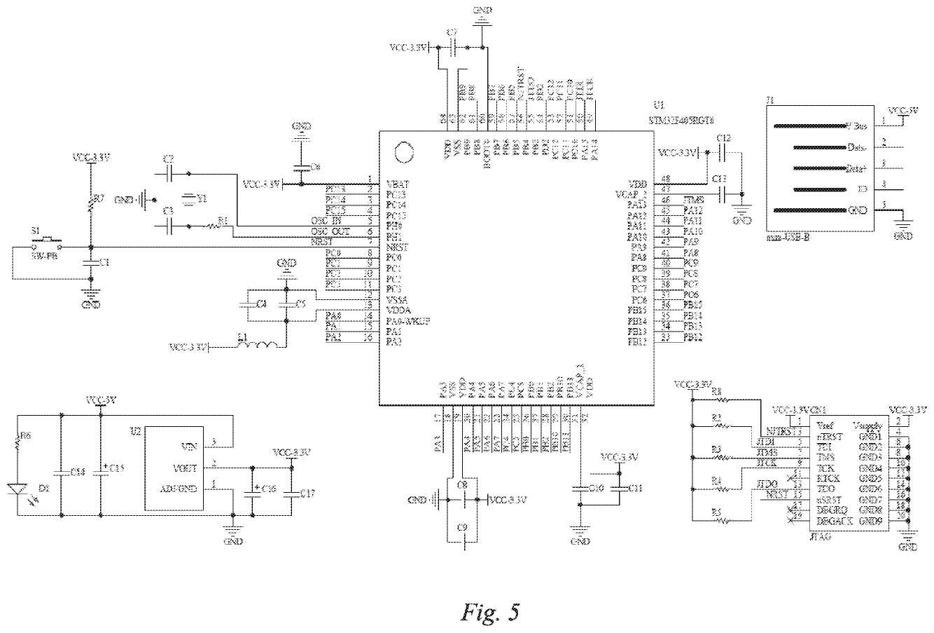

As shown in FIG. 5, the DSC controller mainly comprises a DSC micro-controller U1, a power source power supply module composed of a low-dropout linear voltage-stabilized power source AMS1117 (U2), R6, D1 and C14-C15, an external clock circuit composed of C2-C3, a crystal oscillator Y1 and R3, a reset circuit composed of R7, S4 and C1, and a JTAG debug and download circuit composed of R2-R5, R8, a JTAG module, etc.

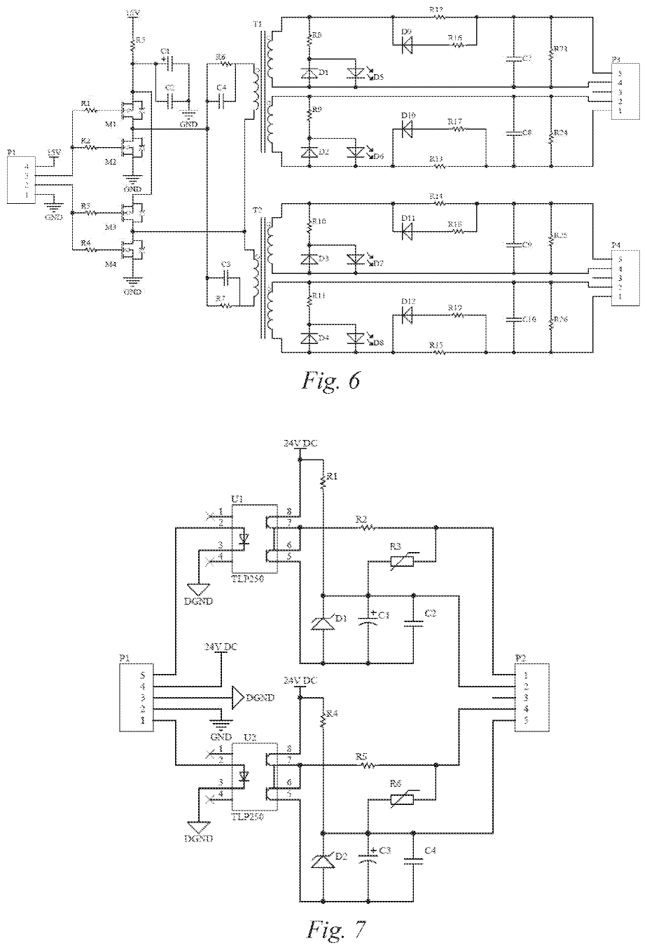

As shown in FIG. 6, the high-frequency inverter drive circuit of the main-arc power source control circuit is a high-frequency pulsed transformer-isolated drive circuit, which mainly composed of a plug-in port P1, R1-R4, two push-pull output circuits respectively composed of P-channel power field effect transistors IRF9530 M1 and M3 and N-channel power field effect transistors IRF530 M2 and M4, high-frequency pulse voltage devices T1-T2, an IGBT “slow on and fast off” network 1 composed of resistors R12, R16, a diode D9 and a capacitor C7, an IGBT “slow on and fast off” network 2 composed of resistors R13, R17, a diode D10 and a capacitor C8, an IGBT “slow on and fast off” network 3 composed of resistors R14, R18, a diode D11 and a capacitor C9, an IGBT “slow on and fast off” network 4 composed of resistors R15, R19, diode D12 and a capacitor C10, gate resistors R23-R26, plug-in connectors P3-P4, and an auxiliary peripheral circuit. A TTL-type PWM drive signal generated by the DSC microprocessor is input to M1, M2 and M3, M4 respectively after being subjected to high-speed linear isolation, and output signals thereof are then amplified and isolated respectively by the high-frequency pulsed transformers to generate four IGBT drive signals to drive the corresponding IGBTs. The “slow on and fast off” networks can effectively reduce IGBT switching losses. The arc stabilization circuit drive circuit also adopts a similar structure. As shown in FIG. 7, the low-frequency modulation drive circuit of the main-arc power source control circuit uses a high-speed optocoupler TLP250 as the core, and further comprises Zener diodes D1-D2, resistors R2-R6, and capacitors C1-C4. The Zener diodes D1 and D2 provide a negative bias voltage when the IGBT is turned off, so as to ensure a fast and reliable turn-off of the IGBT. The resistors R2 and R5 are gate resistors, while the varistor resistors R3 and R6 provide bypass channels for the disturbing voltage spikes to reliably protect the IGBT.

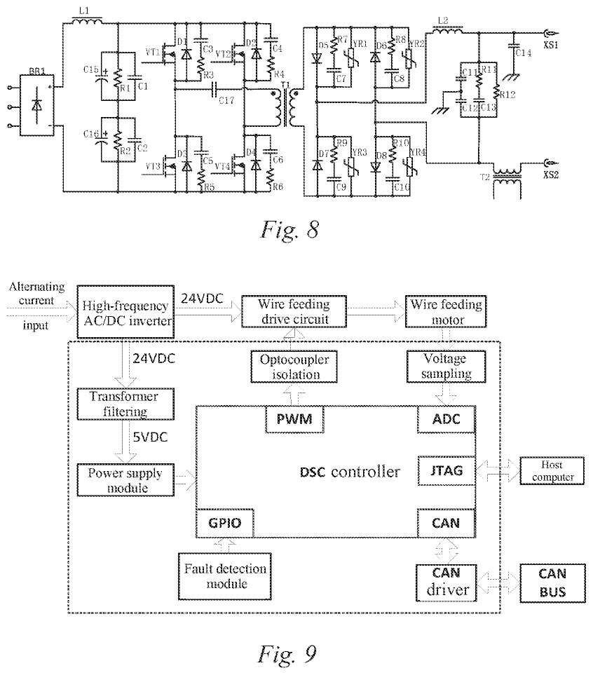

As shown in FIG. 8, a three-phase alternating current input power source in the pilot-arc power source main circuit is connected to an input rectification and filtering module composed of L1, C1, C2, C15, C16, R1, R2 and BR1 after the grid EMI filtering process, and is then connected to inverter bridges VT1-VT4, C3-C6, R3-R6 and D1-D4 of a MOSFET inverter circuit, wherein the inverter frequency is 100 kHz, and the output is fed into the primary side of the intermediate-frequency transformer T1 and the secondary side of the transformer, and passes through a fast rectification and filtering circuit D5-D8, L2, C11-C14, Ru and R12, such that a direct current is output. The above links constitute the main circuit of the pilot-arc Zo power source. The high-frequency signal generated by the high-frequency and high-voltage arc ignition circuit is coupled into the output circuit of the pilot-arc power source through the transformer T2.

As shown in FIG. 9, the wire feeding machine mainly comprises a control system, a high-frequency AC/DC inverter, a wire feeding drive circuit, a wire feeding motor, pinch rollers, and a fixed bracket. The wire feeding machine control system comprises a DSC controller, an optocoupler isolation module, a voltage sampling module, a transformer filtering module, a power supply module, a fault detection module, a CAN driver, etc.

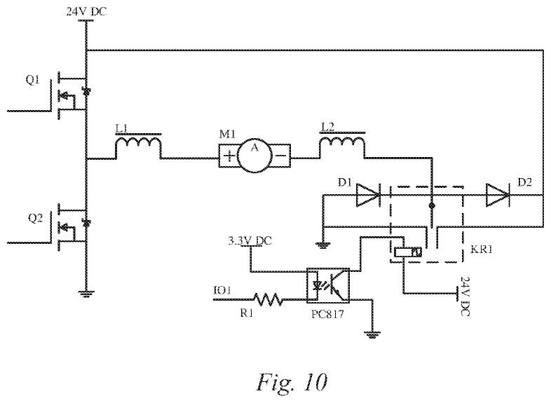

As shown in FIG. 10, the wire feeding drive circuit of the wire feeding machine that mainly consists of a high-frequency half-bridge chopper circuit composed of MOSFET power transistors Q1-Q2, diodes D1-D2, a relay switch KR1, an optocoupler PC817, and an equivalent motor load, can realize working modes such as forward wire feeding, reverse wire drawing and pulsating wire feeding with adjustable speeds. The rotation speed of the motor can be adjusted steplessly, and fluctuations in the rotation speed of the motor caused by fluctuations in power supply voltage and changes in internal resistance of the power source can be compensated.

The working principle of the present invention is as follows:

firstly, selecting, by an industrial computer according to the characteristics of a workpiece and a wire therefor, a corresponding additive manufacturing mode and a basic process parameter supporting same; secondly, detecting, by a machine visual system, information of the workpiece to be additively manufactured and the position thereof, and feeding the information into the industrial computer and plan an additive path to coordinate the movements of an industrial robot and an auxiliary tooling fixture to corresponding workstations; and activating a refrigerating device and a gas device to prepare for the work of a plasma welding gun and an additive manufacturing power source. A three-phase power source supplies power to the additive manufacturing power source and a wire feeding machine to start an additive manufacturing work. A pilot-arc power source of the additive manufacturing power source works first, a high-frequency and high-voltage arc ignition circuit is used to generate a high-frequency and high-voltage signal to break down an air gap between a tungsten electrode and a nozzle of the plasma welding gun to establish and sustain an arc with a very small current. After the ignition of the arc is successful, a DSC controller of the pilot-arc power source sends a pilot-arc success signal to a controller of a main-arc power source, and the main-arc power source is activated to generate a transfer arc between the workpiece and the tungsten electrode. after the transfer arc is successful, the additive manufacturing system can turn off a pilot arc according to the requirements of materials and processes, so as to perform the additive manufacturing process in the case of the transfer arc; and The pilot arc can also continue to work, so as to form a mixed arc of the pilot arc and the transfer arc for additive manufacturing. The wire is fed stably by the wire feeding machine according to predetermined process requirements, and the wire is melted by a plasma arc jet generated by the plasma welding gun, and is stacked and shaped following the corresponding path. In order to finely control the amount of heat input and the amount of molten metal, an output waveform of the main-arc power source may have various shapes, including reverse polarity, variable polarity, pulse, etc. The wire feeding speed may also be constant or be a variable speed or change in a pulsating manner, etc. The state information of the industrial robot, the additive manufacturing power source, the wire feeding machine, the gas device, the auxiliary tooling fixture, etc. are fed into the industrial computer over the CAN bus network for data processing and remote centralized monitoring, thereby further improving the level of automation and intelligence of the additive manufacturing process.

Although the embodiments of the present invention have been shown and described, it can be understood by those of ordinary skill in the art that various changes, modifications, substitutions and variations can be made to these embodiments without departing from the principles and spirit of the present invention, and the scope of the present invention is defined by the appended claims and their equivalents.

1. A reverse polarity plasma arc robot additive manufacturing system, comprising an industrial robot, an additive manufacturing power source, a wire feeding machine, a machine visual system, an industrial computer, a plasma welding gun, a refrigerating device, a gas device and an auxiliary tooling fixture, wherein the industrial robot, the additive manufacturing power source, the wire feeding machine, the refrigerating device, the gas device and the auxiliary tooling fixture are all connected to the industrial computer via a CAN bus; the machine visual system is connected to the industrial computer over a TCP/IP protocol; the plasma welding gun is connected to the refrigerating device, the additive manufacturing power source, the wire feeding machine, the gas device and the auxiliary tooling fixture; and the refrigerating device is further connected to the additive manufacturing power source, wherein
the machine visual system is used to detect information of a workpiece to be additively manufactured and location information thereof, and feed the information into the industrial computer; the machine visual system is used to identify a path, monitor a state and track the workpiece during additive manufacturing;
the industrial computer is used to select an additive manufacturing mode and a basic process parameter supporting same, and plan an additive path; the industrial computer performs data processing and remote monitoring on the industrial robot, the additive manufacturing power source, the wire feeding machine, the gas device and the auxiliary tooling fixture during the additive manufacturing;
the industrial robot serves as an execution mechanism for controlling the plasma welding gun and the auxiliary tooling fixture to complete corresponding action operations;
the additive manufacturing power source is used to provide energy required during the additive manufacturing;
the wire feeding machine is used to convey a wire and adjust a feeding speed;
the plasma welding gun is used to complete energy conversion so as to provide energy and power for wire fused deposition and transition of molten metal;
the refrigerating device is used to provide cooling for the additive manufacturing power source and the plasma welding gun;
the gas device is used to provide an ionized gas and a shielding gas to the plasma welding gun; and
the auxiliary tooling fixture is used to complete clamping and displacement operations of the workpiece.

2. The reverse polarity plasma arc robot additive manufacturing system according to claim 1, wherein the additive manufacturing power source comprises a main-arc power source and a pilot-arc power source, and the main-arc power source and the pilot-arc power source are both connected to the plasma welding gun; and the main-arc power source comprises a main-arc power source main circuit and a main-arc power source control circuit, and the pilot-arc power source comprises a pilot-arc power source main circuit, a pilot-arc power source control circuit and a high-frequency and high-voltage arc ignition circuit, wherein
the main-arc power source main circuit is used to realize the conversion and transmission of main-arc energy;
the main-arc power source control circuit is used to control the normal work of the main-arc power source for each task;
the pilot-arc power source main circuit is used to realize the conversion and transmission of pilot-arc energy;
the pilot-arc power source control circuit is used to control the normal work of the pilot-arc power source for each task; and
the high-frequency and high-voltage arc ignition circuit is used to break down an air gap between a tungsten electrode and a nozzle of the plasma welding gun to establish and sustain an arc.

3. The reverse polarity plasma arc robot additive manufacturing system according to claim 2, wherein the main-arc power source main circuit adopts a dual inverter topology, comprising an input rectification and filtering module, an IGBT high-frequency inverter circuit, an intermediate-frequency transformer, a fast rectification and filtering module, an IGBT low-frequency modulation circuit, and a high-voltage arc stabilization circuit, wherein the input rectification and filtering module is used to convert 380V three-phase alternating current into smooth direct current; the IGBT high-frequency inverter circuit is used to invert the rectified direct current into high-frequency alternating current; the intermediate-frequency transformer is used for energy conversion, so as to provide high-current and low-voltage alternating current required during the additive manufacturing; the fast rectification and filtering module is used to convert the alternating current, which has passed through the intermediate-frequency transformer, into large-current and low-voltage direct current; the IGBT low-frequency modulation circuit is used to perform commutation adjustment, frequency modulation, and inductive filtering on the direct current, which has passed through the fast rectification and filtering module, to output required current and voltage waveforms; and the high-voltage arc stabilization circuit is used to ensure that a relatively high voltage is applied at the time of polarity switching of the output current of the IGBT low-frequency modulation circuit to ensure reliable re-ignition of the arc when the current crosses zero.

4. The reverse polarity plasma arc robot additive manufacturing system according to claim 2, wherein the main-arc power source control circuit comprises a DSC controller, a high-frequency inverter drive circuit, an over-current detection circuit, a current feedback circuit, a low-frequency modulation drive circuit, an arc stabilization circuit drive circuit, a human-machine interaction system, an overheat detection circuit, an over-voltage detection circuit, an under-voltage detection circuit and a CAN communication interface circuit, wherein
the DSC controller generates three sets of all-digitized PWM control signals, and controls the low-frequency modulation drive circuit, the high-frequency inverter drive circuit, and the arc stabilization circuit drive circuit respectively;
the high-frequency inverter drive circuit is used to convert the PWM control signal generated by the DSC controller into a drive signal required by a power switching transistor IGBT in the IGBT high-frequency inverter circuit;
the over-current detection circuit is used to prevent the current passing through the power switching transistor IGBT from being excessive;
the current feedback circuit is used to implement closed-loop adjustment of the output current of the power source;
the low-frequency modulation drive circuit is used to convert the PWM control signal generated by the DSC controller into a drive signal required by a power switching transistor IGBT in the IGBT low-frequency modulation circuit;
the arc stabilization circuit drive circuit is used to convert the PWM control signal generated by the DSC controller into a drive signal required by a power switching transistor IGBT in the high-voltage arc stabilization circuit;
the human-machine interaction system is used to implement a dialog between a human and the power source;
the overheat detection circuit is used to prevent the temperatures of the power switching transistor IGBTs from becoming too high;
the over-voltage detection circuit is used to detect whether the 380V three-phase alternating-current voltage input by the power source is too high;
the under-voltage detection circuit is used to detect whether the 380V three-phase alternating-current voltage input by the power source is too low; and
the CAN communication interface circuit is used to communicate with other systems to achieve digitized collaboration.

5. The reverse polarity plasma arc robot additive manufacturing system according to claim 4, wherein the DSC controller comprises a DSC microcontroller, a power source power supply module, an external clock circuit, a reset circuit, and a JTAG debug and download circuit.

6. The reverse polarity plasma arc robot additive manufacturing system according to claim 2, wherein the pilot-arc power source main circuit comprises an input rectification and filtering module, a MOSFET inverter circuit, an intermediate-frequency transformer, and a fast rectification and filtering module, wherein the input rectification and filtering module is used to convert 380V three-phase alternating current into smooth direct current; the MOSFET inverter circuit is used to invert the rectified direct current into high-frequency alternating current; the intermediate-frequency transformer is used for energy conversion, so as to obtain high-current and low-voltage alternating current; and the fast rectification and filtering module is used to convert the alternating current, which has passed through the intermediate-frequency transformer, into large-current and low-voltage direct current.

7. The reverse polarity plasma arc robot additive manufacturing system according to claim 1, wherein the wire feeding machine comprises a wire feeding control system, a high-frequency AC/DC inverter, a wire feeding drive circuit, a wire feeding motor, pinch rollers, and a fixed bracket, wherein the wire feeding control system comprises a DSC controller, an optocoupler isolation module, a voltage sampling module, a transformer filtering module, a power supply module, a fault detection module and a CAN driver.

8. The reverse polarity plasma arc robot additive manufacturing system according to claim 7, wherein the wire feeding drive circuit comprises a high-frequency half-bridge chopper circuit, two diodes, a relay switch, an optocoupler, and a motor load.

9. A method for implementing a reverse polarity plasma arc robot additive manufacturing system, comprising the following steps:
S1. selecting, by an industrial computer according to the characteristics of a workpiece and a wire therefor, a corresponding additive manufacturing mode and a basic process parameter supporting same; and detecting, by a machine visual system, information of the workpiece to be additively manufactured and the position thereof, and feeding the information into the industrial computer and plan an additive path to coordinate the movements of an industrial robot and an auxiliary tooling fixture to corresponding workstations;
S2. activating a refrigerating device and a gas device to prepare for the work of a plasma welding gun and an additive manufacturing power source;
S3. switching on a three-phase power source to supply power to the additive manufacturing power source and a wire feeding machine for conducting an additive manufacturing work; and
S4. feeding the wire stably by the wire feeding machine according to process requirements pre-set by the industrial computer, and melting the wire by a plasma arc jet generated by the plasma welding gun, and stacking and shaping the wire following the corresponding path.

10. The method for implementing a reverse polarity plasma arc robot additive manufacturing system according to claim 9, wherein in step S3, after the three-phase power source supplies power to the additive manufacturing power source, a pilot-arc power source of the additive manufacturing power source works first, a high-frequency and high-voltage arc ignition circuit is used to generate a high-frequency and high-voltage signal to break down an air gap between a tungsten electrode and a nozzle of the plasma welding gun to establish and sustain an arc with a very small current; after the ignition of the arc is successful, a DSC controller of the pilot-arc power source sends a pilot-arc success signal to a DSC controller of a main-arc power source, and the main-arc power source is activated to generate a transfer arc between the workpiece and the tungsten electrode; after the transfer arc is successful, the additive manufacturing system can turn off a pilot arc according to the requirements of materials and processes, so as to perform the additive manufacturing process in the case of the transfer arc; and the pilot arc can also continue to work, so as to form a mixed arc of the pilot arc and the transfer arc for additive manufacturing,
wherein, in order to finely control the amount of heat input and the amount of molten metal, an output waveform of the main-arc power source includes reverse polarity, variable polarity, and pulse; and the wire feeding speed is constant or is a variable speed or changes in a pulsating manner.
